(19) United States
(12) Patent Application Publication
(10) Pub. No.: US 2020/0406660 A1
(43) Pub. Date: Dec. 31, 2020

(54) PRINTING PLATE FOR MONOTYPE PRINTS HAVING VISCOELASTIC GELS AND METHOD FOR ITS USE

(71) Applicant: Robert D. Kross, Bellmore, NY (US)

(72) Inventor: Robert D. Kross, Bellmore, NY (US)

(21) Appl. No.: 17/019,517

(22) Filed: Sep. 14, 2020

Related U.S. Application Data
(63) Continuation of application No. 13/275,400, filed on Oct. 18, 2011.
(60) Provisional application No. 61/460,209, filed on Dec. 29, 2010.

(51) Int. Cl. B41N 1/00; B41N 1/12

(52) U.S. Cl. CPC B41N 1/006; B41C 3/06; B41N 1/12

(57) ABSTRACT

A printing plate for monotype prints includes a viscoelastic gel composition having a viscoelastic polymer selected from a hydrogenated poly-isoprene/butadiene polymer, poly(styrene-butadiene-styrene), poly(styrene-butadiene)ₙ, poly(styrene-isoprene-styrene), poly(styrene-isoprene)ₙ, poly(styrene-ethylene-propylene), poly(styrene-ethylene-propylene-styrene)ₙ, poly(styrene-ethylene-butylene-styrene)ₙ, poly(styrene-ethylene-butylene), poly(styrene-ethylene-propylene)ₙ, poly(styrene- ethylene-butylene)ₙ, polystyrene, polybutylene, poly(ethylene-propylene), poly(ethylene-butylene), polypropylene, polyethylene, polyurethane and silicone, and a combination thereof, and a plasticizing oil. The viscoelastic gel composition has a smooth surface and is formed as a sheet and shaped for use as a printing plate. A method for using the elastomeric gel printing plates of the present invention is also provided.

### CROSS-REFERENCE TO RELATED APPLICATION

The inventor claims domestic priority, pursuant to 35 U.S.C. § 119(e), on the basis of U.S. Provisional Patent Application No. 61/460,209, filed Dec. 29, 2010, the entire disclosure of which shall be deemed to be incorporated by reference herein.

### BACKGROUND OF THE INVENTION

### Technical Field of the Invention

The present invention relates, generally, to a printing plate for monotype prints comprising a viscoelastic gel, along with a related method for using such “gel printing plates” for creating various forms of printed matter, including prints having creative design features.

More particularly, the present invention relates to the application of viscoelastic-type oil-based products as print-making surfaces for creating monotype prints prepared without a press.

### Description of the Prior Art

Printing processes, such as offset lithography, use printing plates to transfer an image to paper or other substrates. The plates may be made of metal, plastic, rubber, paper and other materials. The image is put on the printing plates using photomechanical, photochemical or laser engraving processes, and the image may be either a positive or a negative. Typically, but not always, printing plates are attached to a cylinder in the press. Paint or ink is applied to the plate's image area and transferred directly to the paper or to an intermediary cylinder and then to the paper.

A monotype print is a traditional fine art print made by pressing a piece of paper (often a damp sheet) against a painted or inked surface. The plate used for a monoprint only exists once, so each monoprint is unique. While additional prints can be made. if the plate still has enough paint on it, the second print will vary substantially from the first. This process has a number of considerations with regard to the plate surface, including smoothness, ability to accept a variety of paints and inks, ease of release of paint or ink, storability under ambient conditions, durability and reusability, and cleanability after use with either a water-based or oil-based paint or ink. The current printing plates for mono-type printing do not necessarily satisfy all these considerations, and the present invention is a result of a search for an alternative printing plate composition that will meet these needs.

### SUMMARY OF THE INVENTION

It is an object of the present invention to provide a printing plate for producing monotype prints having a viscoelastic gel coating that is a reusable, durable gel printing plate intended for artists' monoprinting techniques without a need for a press or other type of pressure tool.

It is a further object of the present invention to provide a printing plate for producing monotype prints having a viscoelastic gel coating that provides a printing plate having a soft, smooth surface able to accept a wide variety of paints and inks.

It is, yet, a further object of the present invention to provide a printing plate for producing monotype prints having a viscoelastic gel coating providing for ready cleaning, whether the paint used is a water- or oil-based paint.

It is an additional object of the present invention to provide a method for using a printing plate having a viscoelastic gel for producing monotype prints.

The foregoing and related objects are accomplished by the presently claimed invention for a printing plate for monotype prints which is either provided as a gelatinous printing plate, per se, made of a viscoelastic oil-based plasticized polymer composition or, in the alternative, is provided as a viscoelastic oil-based plasticized polymer composition on a substrate, which compositions include hydrogenated poly-isoprene/butadiene (“SEEPS”) polymers, which are comprised of block segments of styrene monomer units and hydrogenated conjugated diene monomer units. The foregoing SEEPS compositions, as referred to as “Septon SEEPS,” are available from Kuraray America, Inc., 2625 Bay Area Boulevard, Houston, Tex. 77058, U.S.A. Additional polymer compositions useful in practicing the present invention include a class of gelatinous elastomer compositions, which can be generally described as intimate melt blend admixtures of block SEEPS copolymers in combination with various polymers of poly(styrene-butadiene-styrene), poly(styrene-butadiene)ₙ, poly(styrene-isoprene-styrene), poly(styrene-isoprene)ₙ, poly(styrene-ethylene-propylene), poly(styrene-ethylene-propylene-styrene)ₙ, poly-(styrene-ethylene-butylene-styrene)ₙ, poly(styrene-ethylene-butylene), poly(styrene-ethylene-propylene)ₙ, poly(styrene-ethylene-butylene), polystyrene, polybutylene, poly(ethylene-propylene), poly(ethylene-butylene), polypropylene, polyethylene, polyurethane and silicone, and a plasticizing oil. Such compositions, in addition to other compositions useful for practicing the presently claimed invention, are disclosed in Chen, U.S. Pat. No. 7,159,259 with all such useful compositions disclosed therein being incorporated herein by reference.

A method for using the elastomeric gel printing plates of the present invention is also provided.

Other objects and features of the present invention will become apparent when considered in combination with the following detailed description of the invention, which provides certain preferred embodiments and examples of the present invention. It should, however, be noted that the accompanying detailed description is intended to discuss and explain only certain embodiments of the claimed invention and is not intended as a means for defining the limits and scope of the invention.

### DETAILED DESCRIPTION OF THE PREFERRED EMBODIMENTS

The printing plate for monotype prints of the present invention is preferably provided as a gelatinous printing plate, per se, made of a viscoelastic oil-based plasticized polymer composition comprised of one or more hydrogenated poly-iso-prene/butadiene (“SEEPS”) polymers and/or an intimate melt blend admixture of block SEEPS copolymers in combination with various polymers of poly(styrene-butadiene-styrene), poly(styrene-butadiene)ₙ, poly(styrene-isoprene-styrene), poly(styrene-isoprene)ₙ, poly(styrene-ethylene-propylene), poly(styrene-ethylene-propylene-styrene)ₙ, poly-(styrene-ethylene-butylene-styrene)ₙ, poly(styrene-ethylene-butylene), poly(styrene-ethylene-propylene)ₙ, poly(styrene-ethylene-butylene)ₙ, polystyrene, polybutylene, poly(ethylene-propylene), poly(ethylene-butylene), polypropylene, polyethylene, polyurethane and silicone, and a plasticizing oil. The gel printing plate of the present invention has an extremely sensitive surface and will imprint any texture on which it is placed.

The resulting gel printing plate made in accordance with the present invention results in the gel printing plate preferably having a soft, smooth surface with a gel “feel” that is capable of accepting a wide variety of paints and inks. The most preferred paints for use with the gel printing plate of the present invention are acrylic paints, which can easily be cleaned from the printing plate with mild soap and water, followed by rinsing and gently patting the printing plate dry with a paper towel. When using acrylic paints, it is not necessary to clean the gel printing plate between prints. Interestingly, a paint residue can contribute to quite surprising and pleasing aesthetic printing results.

Oil-based paints may also be used with the gel printing plate of the present invention, and can be easily cleaned from the gel printing plate by rubbing the surface of the printing plate with baby oil and wiping clean with a paper towel. The gel printing plate is subsequently washed with mild soap and water, rinsed and patted dry.

If the gel printing plate is constructed to include a supporting substrate on which the viscoelastic gel is placed, any such substrate should preferably be a smooth, flat, non-porous barrier surface, preferably made of Teflon® (polytetrafluoroethylene) or glass.

The inventive method for using the elastomeric, or viscoelastic, gel printing plate of the claimed invention includes the steps of applying a thin layer of paint (preferably using a brayer or paintbrush) to create a design. Paper, for example, is then laid over the painted gel plate and may be rubbed by hand for transferring the paint to the paper, thereby resulting in a printed image. The advantages and attributes of this inventive method include the following:
the gel printing plate's soft, smooth surface accepts a wide variety of paints and inks;
the paint or ink releases easily under minimal hand pressure for an effortless transfer print;
the gel printing plate stores at room temperature and is ready for immediate use;
the gel printing plate is always ready to print with; requiring no special preparations;
the gel printing plate is durable and reusable; and,
the gel printing plate of the present invention is readily able to be cleaned.

As a result, the present invention provides a reusable, durable gel printing plate designed for artists' monoprinting techniques without the need for a press or other pressure tools. The inventive gel printing plate replaces the need to prepare natural gelatin plates for similar printmaking processes that artists have conventionally used.

While only several embodiments of the present invention have been shown and described, it will be obvious to those skilled in the art that many modifications may be made to the present invention without departing from the spirit and scope thereof.

1-12. (canceled)

13. A printing apparatus using a non-gelatin, viscoelastic gel printing plate for producing a plurality of prints, comprising:
an acrylic paint;
a non-gelatin, viscoelastic gel printing plate capable of producing a first print, said non-gelatin, viscoelastic gel printing plate comprising a viscoelastic gel composition having a viscoelastic polymer selected from the group consisting of a hydrogenated poly-isoprene/butadiene polymer, poly(styrene-butadiene-styrene), poly(styrene-butadiene)ₙ, poly(styrene-iso-prene-styrene), poly-(styrene-isoprene)ₙ, poly(styrene-ethylene-propylene), poly(styrene-ethylene-propylene-styrene)ₙ, poly(styrene-ethylene-butylene-styrene)ₙ, poly(styrene-ethylene-butylene), poly(styrene-ethylene-propylene)ₙ, poly(styrene-ethylene-butylene)ₙ, polystyrene, polybutylene, poly(ethylene-propylene), poly(ethylene-butylene), polypropylene, polyethylene, polyurethane, polyethylene and silicone, and a combination thereof, and a plasticizing oil, said viscoelastic gel composition excludes gelatin and has a smooth surface formed as a sheet and shaped for use as said non-gelatin, viscoelastic gel printing plate;
a smooth, flat, nonporous barrier surface onto which said acrylic paint for creating a first print is to be transferred from said non-gelatin, viscoelastic gel printing plate;
means for applying pressure for transferring at least a portion of said acrylic paint from said non-gelatin, visco-elastic gel printing plate to said smooth, flat, nonporous barrier surface for producing said first print; and,
means for applying pressure for transferring at least a portion of said acrylic paint from said non-gelatin, visco-elastic gel printing plate to said smooth, flat, nonporous barrier surface for producing a second print, said printing apparatus excluding means for cleaning said acrylic paint from said smooth, flat, nonporous barrier surface prior to producing said second print.

14. The printing apparatus using a non-gelatin, viscoelastic gel printing plate for producing a plurality of prints according to claim 12, wherein said smooth, flat, nonporous barrier surface includes polytetrafluoroethylene.

15. The printing apparatus using a non-gelatin, viscoelastic gel printing plate for producing a plurality of prints according to claim 13, further comprising means for storage of said printing apparatus, including said non-gelatin, viscoelastic gel printing plate, at room temperature.

16. A printing apparatus using a non-gelatin, viscoelastic gel printing plate for producing a plurality of prints, comprising:
an oil-based paint;
a non-gelatin, viscoelastic gel printing plate capable of producing a first print, said non-gelatin, viscoelastic gel printing plate comprising a viscoelastic gel composition having a viscoelastic polymer selected from the group consisting of a hydrogenated poly-isoprene/butadiene polymer, poly(styrene-butadiene-styrene), poly(styrene-butadiene)ₙ, poly(styrene-iso-prene-styrene), poly-(styrene-isoprene)ₙ, poly(styrene-ethylene-propylene), poly(styrene-ethylene-propylene-styrene)ₙ, poly(styrene-ethylene-butylene-styrene)ₙ, poly(styrene-ethylene-butylene), poly(styrene-ethylene-propylene)ₙ, poly(styrene-ethylene-butylene)ₙ, polystyrene, polybutylene, poly(ethylene-propylene), poly(ethylene-butylene), polypropylene, polyethylene, polyurethane, polyethylene and silicone, and a combination thereof, and a plasticizing oil, said viscoelastic gel composition excludes gelatin and has a smooth surface formed as a sheet and shaped for use as said non-gelatin, viscoelastic gel printing plate;
a smooth, flat, nonporous barrier surface onto which said oil-based paint for creating a first print is to be transferred from said non-gelatin, viscoelastic gel printing plate;
means for applying pressure for transferring at least a portion of said oil-based paint from said non-gelatin, visco-elastic gel printing plate to said smooth, flat, non-porous barrier surface for producing said first print;
means for cleaning said non-gelatin, visco-elastic gel printing plate after producing first print, said means for cleaning including baby oil and a paper towel; and,
means for applying pressure for transferring at least a portion of said oil-based paint from said non-gelatin, visco-elastic gel printing plate to said smooth, flat, non-porous barrier surface for producing a second print.

17. The printing apparatus using a non-gelatin, viscoelastic gel printing plate for producing a plurality of prints according to claim 16, wherein said smooth, flat, nonporous barrier surface includes polytetrafluoroethylene.

18. The printing apparatus using a non-gelatin, viscoelastic gel printing plate for producing a plurality of prints according to claim 16, further comprising means for storage of said printing apparatus, including said non-gelatin, viscoelastic gel printing plate, at room temperature.

19. A printing apparatus using a non-gelatin, viscoelastic gel printing plate for producing a plurality of prints, comprising:
a water-based paint;
a non-gelatin, viscoelastic gel printing plate capable of producing a first print, said non-gelatin, viscoelastic gel printing plate comprising a viscoelastic gel composition having a viscoelastic polymer selected from the group consisting of a hydrogenated poly-isoprene/butadiene polymer, poly(styrene-butadiene-styrene), poly(styrene-butadiene)ₙ, poly(styrene-iso-prene-styrene), poly-(styrene-isoprene)ₙ, poly(styrene-ethylene-propylene), poly(styrene-ethylene-propylene-styrene)ₙ, poly(styrene-ethylene-butylene-styrene)ₙ, poly(styrene-ethylene-butylene), polystyrene-ethylene-propylene)ₙ, poly(styrene-ethylene-butylene)ₙ, polystyrene, polybutylene, poly(ethylene-propylene), poly(ethylene-butylene), polypropylene, polyethylene, polyurethane, polyethylene and silicone, and a combination thereof, and a plasticizing oil, said viscoelastic gel composition excludes gelatin and has a smooth surface formed as a sheet and shaped for use as said non-gelatin, viscoelastic gel printing plate;
a smooth, flat, nonporous barrier surface onto which said water-based paint for creating a first print is to be transferred from said non-gelatin, viscoelastic gel printing plate;
means for applying pressure for transferring at least a portion of said water-based paint from said non-gelatin, visco-elastic gel printing plate to said smooth, flat, non-porous barrier surface for producing said first print;
means for cleaning said non-gelatin, visco-elastic gel printing plate after producing first print, said means for cleaning including mild soap and water; and,
means for applying pressure for transferring at least a portion of said water-based paint from said non-gelatin, visco-elastic gel printing plate to said smooth, flat, non-porous barrier surface for producing a second print.

20. The printing apparatus using a non-gelatin, viscoelastic gel printing plate for producing a plurality of prints according to claim 19, wherein said smooth, flat, nonporous barrier surface includes polytetrafluoroethylene.

21. The printing apparatus using a non-gelatin, viscoelastic gel printing plate for producing a plurality of prints according to claim 19, further comprising means for storage of said printing apparatus, including said non-gelatin, viscoelastic gel printing plate, at room temperature.
